(19) United States
(12) Patent Application Publication
(10) Pub. No.: US 2026/0285276 A1
(43) Pub. Date: Sep. 24, 2026

(54) BRAKE SYSTEM FOR MOTOR VEHICLES WITH A PRESSURE SUPPLY DEVICE

(71) Applicant: Continental Automotive Technologies GmbH, Hannover (DE)

(72) Inventor: Stefan Gottschalk, Oberursel (DE)

(73) Assignee: Continental Automotive Technologies GmbH, Hannover (DE)

(21) Appl. No.: 18/868,891

(22) PCT Filed: May 12, 2023
(86) PCT No.: PCT/DE2023/200095

§ 371 Date: Nov. 25, 2024

(30) Foreign Application Priority Data
May 24, 2022 (DE) 10 2022 205 185.8

(51) Int. Cl. B60T 13/14; B60T 7/04; B60T 13/74

(52) U.S. Cl. CPC B60T 13/148; B60T 7/042; B60T 13/745; B60T 2270/402

(57) ABSTRACT

A brake system for motor vehicles includes an electrically controllable pressure supply device and a pressure modulator, to which hydraulic wheel brakes may be connected, and also a reservoir for brake fluid. The electrically controllable pressure supply device has an open-loop and closed-loop control unit which is connected at a signal input end to a braking request apparatus. The electrically controllable pressure supply device is connected to the reservoir via at least one equalizing opening in a standby state.

### CROSS-REFERENCE TO RELATED APPLICATIONS

This application is a national stage application, filed under 35 U.S.C. § 371, of International Patent Application No. PCT/DE2023/200095, filed on May 12, 2023, which claims priority to German patent application No. 10 2022 205 185.8, filed on May 24, 2022, each of which is incorporated by reference.

### TECHNICAL FIELD

The technical field relates to a brake system for motor vehicles.

### BACKGROUND

The electrification of vehicles is continuously evolving, with the trend leading to brake systems which generate brake pressure independently of a vacuum. Examples of vacuum-independent brake systems are brake systems with a brake pedal-actuated brake master cylinder and an electrically controllable pressure supply device. Here, an electric motor moves a hydraulic piston of the pressure supply device in order to provide the desired pressure. In the normal operating mode (by-wire operating mode), at least during braking, the brake pedal is decoupled from the two brake circuits and connected to a simulator which creates the pedal feel. However, these systems still have a mechanical/hydraulic connection from the brake pedal to the hydraulic wheel brakes or a hydraulic fallback level, in which the driver can generate a braking force on the wheels by muscle power and with the aid of the hydraulic transmission ratio of the brake system in an unamplified manner.

In the case of partially or fully autonomous vehicles, the driver is not always actively involved in the driving situation. As a result, a second electrically controllable pressure actuator is required in order to still be capable of braking in the event of failure of the main pressure actuator.

By-wire brake systems are also becoming increasingly relevant owing to the development of modular vehicle construction systems or skateboard chassis. The need for greater flexibility and freedom in the arrangement of the brake system components becomes evident.

The component which generates the brake pressure is referred to below as the pressure supply device or pressure supply means. The generated brake pressure is the same for all wheels and is therefore referred to as the central pressure. If the pressure on individual wheels is to be limited, e.g. because a wheel has to be slip-controlled, the pressure modulator of the brake system assumes this task.

DE 10 2010 024 739 A1 discloses a vehicle brake system comprising an electrically actuated brake force generator, which is arranged between a brake pedal and a tandem brake master cylinder, and a pneumatic pedal simulator, which is coupled to the brake pedal. The tandem brake master cylinder is actuated by the driver by means of the brake pedal in a mechanical fallback level. Here, the pneumatic pedal simulator comprises a housing with a compression chamber and comprises a device for reducing the volume of the compression chamber.

DE 10 2019 213 886 A1 describes a brake system for motor vehicles comprising an ESC module and an electric brake booster, wherein a pedal simulator unit comprising a brake pedal with a mechanical gap is connected upstream of the electric brake booster, so that mechanical actuation of the brake booster by means of the brake pedal takes place once the mechanical gap has been closed.

One disadvantage of the systems described above which have a mechanical/hydraulic connection from the brake pedal to the hydraulic wheel brakes and a hydraulic fallback level is that they have tight limits with regard to their installation in the vehicle. The mechanical components have to be designed and positioned in such a way that the driver can actuate them from the driver's seat. This actuation can be ensured purely mechanically by a linkage or by hydraulic transmission by means of a remote pedal actuation unit (remote-PAU). However, flexibility is limited in this case too. When using an electric brake pedal, this mechanical connection is dispensed with.

Purely electric brake systems are known, wherein the driver's braking request is transmitted purely electrically. However, an electric brake pedal for detecting the driver's request without a hydraulic connection to the brake system requires a redundancy in the generation of braking force, ideally with a very high degree of fail-safety.

If hydraulic brake calipers which are still based entirely or else only partially on hydraulic energy transfer are used in the brake system, a new type of braking force actuator is required, which is intended to shift the volume of brake fluid and thereby generate pressure in the brake system.

### SUMMARY

The disclosure presents a brake system having hydraulic wheel brakes with a high level of availability in the event of a fault and a high degree of fail-safety, in which brake system the braking request can be electrically generated or detected.

A pressure supply device has an open-loop and closed-loop control unit which is connected at a signal input end to a braking request apparatus, wherein the pressure supply device is connected to a reservoir via at least one equalizing opening in a standby state.

The disclosure is based on the consideration that it would be advantageous if brake pressure generation decoupled from the driver can be provided with the braking force actuator (pressure supply device), which acts as the main pressure actuator and as a volume regulator. This system should work in combination with an electric brake pedal, which detects the driver's request, or in an autonomous vehicle, which calculates its braking demand. The braking force actuator (pressure supply device) should work in conjunction with the ESC system or pressure modulator, which can be used as a redundant pressure actuator and is still used for wheel control functions.

A system of this kind should have a high availability in the event of a fault and a high degree of fail-safety as further requirements. Problems with residual pressures, which occur when applying the integrated parking brake (IPB) or in the case of expansion of components for example, should be avoided. The system should have a redundancy in terms of the pressure setting and an optional redundancy for the integrated parking brake. The system should have few components and therefore be cost-effective to manufacture. In the event of wear, it should be possible to supply the brake system with brake fluid. Finally, the resulting demand for a brake system with an exclusively electric brake pedal should be met. Problems with residual pressures, which occur when applying the integrated parking brake (IPB) or in the case of expansion of components for example, should be avoided.

As has now been recognized, these requirements can be met by way of the braking force actuator (the electrically controllable pressure supply device) working in conjunction with the ESC system or pressure modulator, which can be used as a redundant pressure actuator and is still used for wheel control functions.

The electrically controllable pressure supply device is connected to the reservoir via at least one equalizing opening in a standby state.

The standby state of the pressure supply device may be an unactuated state of the pressure supply device.

In one embodiment, the electrically controllable pressure supply device cannot be either mechanically or hydraulically actuated by a driver with a brake pedal.

In one embodiment, the brake system does not include a driver-actuated mechanical and/or hydraulic fallback level.

In one advantageous embodiment, the braking request apparatus is in the form of an electric brake pedal or in the form of an autonomous driver (in particular a controller or sensor, which receives electrical information from the pressure actuator via CAN). The electric brake pedal may include a redundant pedal sensor for detecting the pedal position or the pedal travel/pedal angle.

The pressure modulator may be electrically controllable and has at least one electrically actuable inlet valve for each of the hydraulic wheel brakes.

The electrically controllable pressure supply device, the pressure modulator, and the braking request apparatus may be designed as three separate modules or assemblies. In this case, there is a hydraulic connection only between the electrically controllable pressure supply device and the pressure modulator.

The pressure supply device and the pressure modulator may be connected to each other via two hydraulic, pressure-resistant connecting lines. Further hydraulic connecting lines between the pressure supply device and the pressure modulator are not provided. A hydraulic connecting line between the pressure supply device and the braking request apparatus and a hydraulic connecting line between the pressure modulator and the braking request apparatus are not provided.

The pressure modulator advantageously has a separate open-loop and closed-loop control unit, which is connected at the signal input end to the braking request apparatus. In the event of a faulty signal connection between the braking request apparatus and the open-loop and closed-loop control unit, the braking request is still available in the other open-loop and closed-loop control unit, so that a redundancy in terms of open-loop control and closed-loop control is created. In an alternative advantageous embodiment, only one open-loop and closed-loop control unit is provided, which has two separate circuit boards, wherein the open-loop and closed-loop control routines for the pressure supply device are implemented on the first circuit board and the open-loop and closed-loop control routines for the pressure actuator are implemented on the second circuit board using software and/or hardware.

The pressure modulator advantageously has at least one electrically controllable pressure actuator. In this way, the pressure modulator can still build up brake pressure if the pressure supply device fails or malfunctions.

The respective pressure actuator may be implemented in the form of a pump. If two different pumps are used here, for example a plunger pump and a two-piston pump, their respective disadvantages can be compensated for. Costs can be saved by using a two-piston pump.

In one embodiment, the two open-loop and closed-loop control units are configured in such a way that, in the event of failure or malfunctioning of one of the two open-loop and closed-loop control units, the other open-loop and closed-loop control unit takes over the open-loop and closed-loop control tasks of the failed or faulty open-loop and closed-loop control unit.

The pressure supply device advantageously includes a cylinder-piston arrangement with a primary chamber and a secondary chamber and includes an electric motor, which can be controlled by the open-loop and closed-loop control unit, and also includes a primary piston, which can be moved into the primary chamber by a rotation-translation mechanism. The primary chamber and secondary chamber are advantageously separated from each other by a secondary piston (floating piston). Both the primary chamber and also the secondary chamber may be hydraulically connected or connectable to the reservoir by equalizing openings and corresponding equalizing lines in the standby state, i.e., in an unactuated state of the cylinder-piston arrangement with a retracted (primary) piston. A respective spring element may be arranged in the primary chamber and in the secondary chamber, the spring element moving or holding the primary piston and the floating piston to/in an unactuated state (e.g. at a rear stop) when the electric motor is not actuated.

Two brake circuits may be formed in the pressure modulator, wherein each brake circuit is hydraulically connected to two wheel brakes, and wherein a respective inlet valve and a respective outlet valve are assigned to each wheel brake.

The primary chamber may be connected to one brake circuit of the pressure modulator via a single, first hydraulic connecting line, and the secondary chamber may be connected to the other brake circuit of the pressure modulator via a single, second hydraulic connecting line.

At least two wheel brakes are advantageously equipped with an integrated parking brake. A third electric brake actuation unit, which can be used to brake the vehicle or park it safely, is provided in this way. If these are distributed redundantly to the controllers, pressure actuator and modulator, parking can also be performed redundantly.

The brake system may include a pressure sensor in the pressure modulator, which pressure sensor is connected at the signal input end to at least one open-loop and closed-loop control unit.

Advantages of the disclosed subject matter include, in particular, that the pressure actuator (electrically controllable pressure supply device) and the pressure modulator (components of ESC systems) can be used with an electric brake pedal. Owing to signal redundancy of the wheel speed sensors, in addition to the normal wheel-specific ABS control with a pressure modulator in the event of a fault, an emergency ABS can also further be implemented with a central pressure by means of the pressure actuator. The system has a redundancy in terms of the pressure setting and an optional redundancy for the integrated parking brake. The brake system has few components and is cost-effective to manufacture. In the event of wear, it is still possible to supply the brake system with brake fluid. The IPB function can be distributed to the ECUs by the pressure actuator and the pressure modulator in order to ensure a redundancy for the integrated parking brake.

### BRIEF DESCRIPTION OF THE DRAWINGS

An exemplary embodiment of the disclosure will be explained in more detail with reference to a drawing, in which, in a highly schematic view:

FIG. 1 shows a first schematic illustration of a brake system, and

FIG. 2 shows a second schematic illustration of a brake system.

### DETAILED DESCRIPTION

Like parts are provided with the same reference signs in the two figures.

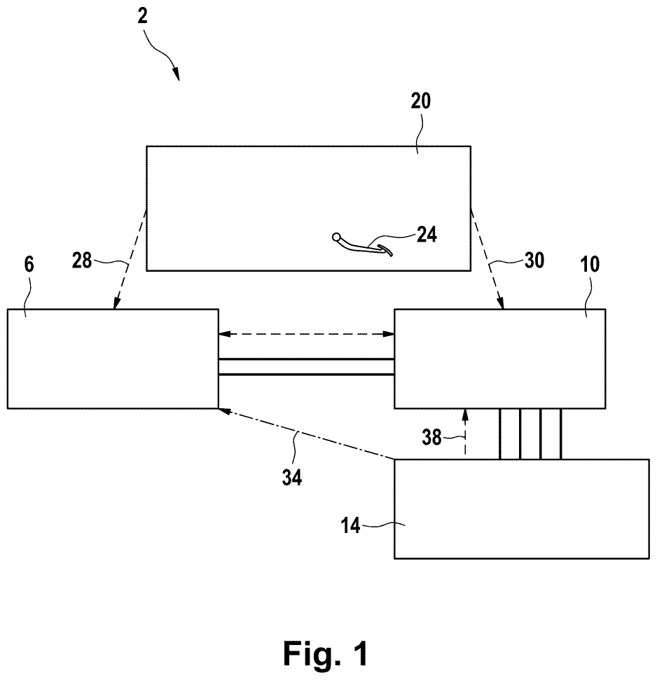

A brake system 2 shown in FIG. 1 includes an electrically controllable pressure supply device 6, a (e.g. electrically controllable) pressure modulator 10, hydraulic wheel brakes 14 and also a braking request apparatus 20. As in the present case, the braking request apparatus 20 can be in the form of a pedal unit with an electric brake pedal 24 with a redundant pedal sensor or alternatively in the form of an autonomous driver (level 5).

The pressure supply device 6 or the pressure supply means operates in conjunction with an electric brake pedal 24, which determines the driver's braking request or the actuation by the driver and transmits it to the pressure supply device 6, this being shown by an arrow 28. Similarly, the driver's braking request is forwarded redundantly to the pressure modulator 10, this being shown by an arrow 30. The pressure supply device 6 generates the desired pressure in the brake system 2. If necessary, the pressure modulator 10 regulates the wheel brake pressure in the wheel brakes 14, in particular based on a control function such as the wheel slip controller for example.

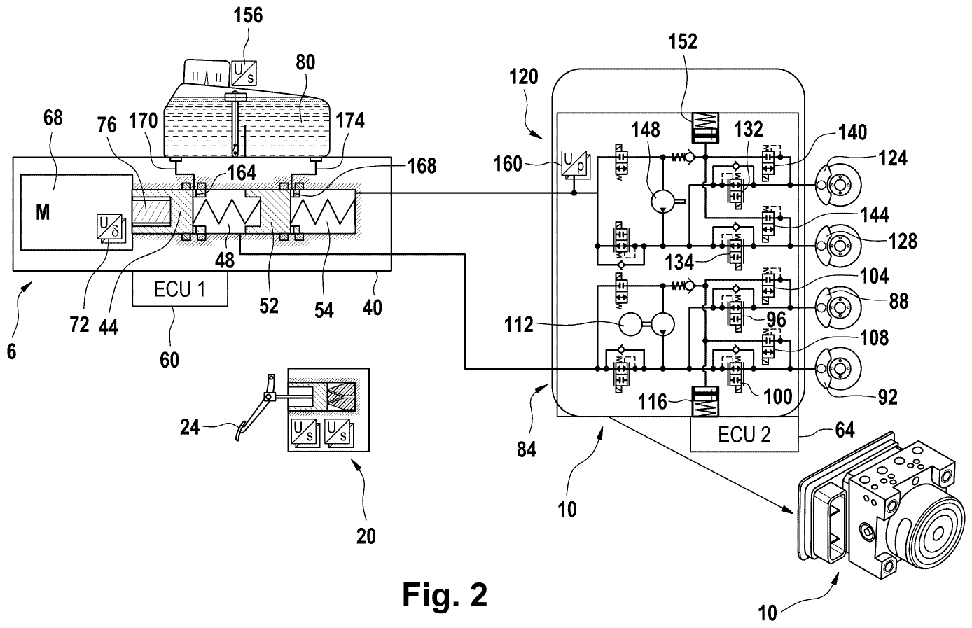

The brake system 2 further includes wheel speed sensors which are connected at the signal input end to an open-loop and closed-loop control unit 60 of the pressure supply device 6 (arrow 34) and the open-loop and closed-loop control unit 64 of the pressure modulator 10 (arrow 38), see FIG. 2.

FIG. 2 shows a further schematic illustration of the brake system 2. The electrically controllable pressure supply device 6 is in the form of a (two-circuit) linear actuator comprising a cylinder-piston arrangement 40 with a primary piston 44, which can be moved back and forth into a hydraulic primary chamber 48, and a floatingly mounted secondary piston 52, which can be moved into a secondary chamber 54. The pressure supply device 6 includes an electric motor 68 and an, in particular redundant, motor position sensor 72. With the aid of a rotation-translation mechanism 76, which is in the form of a ball screw drive by way of example, the rotation of the rotor of the electric motor 68 is converted into a translation of the primary piston 44. The two chambers 48, 54 are connected to a reservoir 80 for brake fluid via equalizing openings 164, 168 (“breather holes”) and equalizing lines 170, 174 in the standby state (unactuated state) of the pressure supply device 6.

The connection to the atmosphere and thus the reduction in residual pressure in the system is ensured by using the cylinder-piston arrangement 40 having breather holes. It is also ensured that brake fluid can continue to run from the brake fluid container or reservoir 80 into the system in the event of wear. There is a dual circuit which is always ensured, even if the supply energy fails.

The primary chamber 48 of the cylinder-piston arrangement 40 is hydraulically connected to a first brake circuit 84 formed in the pressure modulator 10, two wheel brakes 88, 92 being connected to the brake circuit. A respective electrically actuable inlet valve 100, 104 and a respective electrically actuable outlet valve 104, 108 are assigned to each wheel brake 88, 92. Furthermore, a pump 112 and a low-pressure accumulator 116 are arranged in the first brake circuit 84.

The secondary chamber 54 of the cylinder-piston arrangement 40 is hydraulically connected to a second brake circuit 120 formed in the pressure modulator 10, two wheel brakes 124, 128 being connected to the brake circuit. A respective inlet valve 132, 134 and a respective outlet valve 140, 144 are assigned to each wheel brake 124, 128. Furthermore, a pump 148 and a low-pressure accumulator 152 are arranged in the first brake circuit 84.

For faults with a high FIT rate, it has to be possible to operate the pressure supply device 6 independently of the pressure modulator 10. The open-loop and closed-loop control functions are therefore distributed between the two different controllers or open-loop and closed-loop control units 60, 64 or alternatively at least between two different ECU circuit boards. In the event of electrical failure of an open-loop and closed-loop control unit 60, 64 or circuit board, the remaining part can further enable braking force to be generated.

In the event of both electrical and mechanical faults in the pressure supply device 6, all four wheels are decelerated by the pressure modulator 10. The build-up in pressure is generated by the respective pump 112, 148 in the pressure modulator 10. The required brake fluid volume is obtained from the pressure supply device 6 in this case.

In the event of a leak, the dual circuit of the brake system 2 ensures that at least 50% of the brake pressure of the hydraulic system can still always be built up. This proportion can additionally be increased by isolating the leak or by using an integrated parking brake as a braking force actuator. A leak is identified with the aid of a brake fluid sensor 156 or else detected by an increased volume uptake during pressure generation. A pressure sensor 160 in the pressure modulator 10 is used to safeguard the pressure generation.

The pressure supply device does not have any valves. It has only two sensors, specifically the motor position sensor 72 or the position sensor of the drive and the brake fluid level sensor 156. This enables simple operation with few operating software requirements. Both diagonal division and also front-rear division of the brake system 2 can be represented by the described combination of the pressure supply device 6 and the pressure modulator 10. The brake system can thus be easily adapted to the vehicle.

### LIST OF REFERENCE SIGNS

2 Brake system
6 Pressure supply device
10 Pressure modulator
14 Wheel brakes
20 Braking request apparatus
24 Brake pedal
28 Arrow
30 Arrow
34 Arrow
38 Arrow
40 Cylinder-piston arrangement
44 Primary piston
48 Primary chamber
52 Secondary piston
56 Secondary chamber
60 Open-loop and closed-loop control unit
64 Open-loop and closed-loop control unit
68 Electric motor
72 Motor position sensor
76 Rotation-translation mechanism
80 Reservoir
84 First brake circuit
88 Wheel brake
92 Wheel brake
96 Inlet valve
100 Inlet valve
104 Outlet valve
108 Outlet valve
112 Pump
116 Low-pressure accumulator
120 Second brake circuit
124 Wheel brake
132 Inlet valve
134 Inlet valve
140 Outlet valve
144 Outlet valve
148 Pump
152 Low-pressure accumulator
156 Brake fluid sensor
160 Pressure sensor
164 Equalizing opening
168 Equalizing opening
170 Equalizing line
174 Equalizing line

1. A brake system for motor vehicles, comprising:
an electrically controllable pressure supply device;
a pressure modulator connectable to hydraulic wheel brakes; and
a reservoir for brake fluid;
wherein the electrically controllable pressure supply device includes an open-loop and closed-loop control unit which is connected at a signal input end to a braking request apparatus; and
wherein the electrically controllable pressure supply device is connected to the reservoir via at least one equalizing opening in a standby state.

2. The brake system as claimed in claim 1, wherein the braking request apparatus is an electric brake pedal.

3. The brake system as claimed in claim 1, wherein the pressure modulator includes an open-loop and closed-loop control unit which is connected at the signal input end of the braking request apparatus.

4. The brake system as claimed in claim 3, wherein the pressure modulator comprises at least one pressure actuator.

5. The brake system as claimed in claim 4, wherein the respective pressure actuator is a pump.

6. The brake system as claimed in claim 3, wherein the two open-loop and closed-loop control units are configured in such a way that, in the event of failure or malfunctioning of one of the two open-loop and closed-loop control units the other open-loop and closed-loop control unit takes over the open-loop and closed-loop control tasks of the failed or faulty open-loop and closed-loop control unit.

7. The brake system as claimed in claim 1, wherein the electrically controllable pressure supply device comprises
a cylinder-piston arrangement with a primary chamber and a secondary chamber,
an electric motor, which may be controlled by the open-loop and closed-loop control unit, and
a primary piston which may be moved into the primary chamber by a rotation-translation mechanism.

8. The brake system as claimed in claim 1, wherein the electrically controllable pressure supply device cannot be either mechanically or hydraulically actuated by a driver with a brake pedal.

9. (canceled)

10. The brake system as claimed in claim 1, wherein two brake circuits are formed in the pressure modulator, wherein each brake circuit is hydraulically connected to two wheel brakes, and wherein a respective inlet valve and a respective outlet valve are assigned to each wheel brake.

11. The brake system as claimed in claim 1, wherein at least two of the wheel brakes are equipped with an integrated parking brake.

12. The brake system as claimed in claim 1, wherein the pressure modulator further includes a pressure sensor connected at the signal input end to at least one open-loop and closed-loop control unit.

13. The brake system as claimed in claim 1, wherein the electrically controllable pressure supply device, the pressure modulator, and the braking request apparatus are designed as three separate assemblies, wherein in particular there is a hydraulic connection only between the electrically controllable pressure supply device and the pressure modulator.
